(19) United States
(12) Patent Application Publication
(10) Pub. No.: US 2004/0052572 A1
(43) Pub. Date: Mar. 18, 2004

(54) Post binder

(76) Inventor: Richard J. Peters, Fort Lauderdale, FL (US)

Correspondence Address: Oltman, Flynn & Kubler, #415, 915 Middle River Drive, Ft. Lauderdale, FL, 33304-3585, US

(21) Appl. No.: 10/244,920

(22) Filed: Sep. 17, 2002

(51) Int. Cl. B42F 3/00

(52) U.S. Cl. 402/60

(57) ABSTRACT

A post binder comprising: a post unit having upstanding posts positioned to receive the usual openings in loose-leaf pages and each having a series of paired sets of external groves in close succession up along the post; and a page retainer with keyhole openings which pass the posts when the retainer is slid down onto the post unit and which lock into post when the retainer is then shifted horizontally.

### BACKGROUND OF THE INVENTION

Field of the Invention

This invention relates to a post binder for holding a stack of loose-leaf pages in book-like form.

### SUMMARY OF THE INVENTION

The present invention is directed to a novel and advantageous post binder for holding a stack of loose-leaf pages which may change in height as pages are added to or removed from the stack.

A principal object of this invention is to provide a post binder having a novel arrangement for accommodating stacks of loose-leaf pages of different heights.

In a presently preferred embodiment of the invention the post binder comprises: a post unit having a plurality of posts spaced apart in accordance with the spacing between openings in the loose-leaf pages to be held in the binder and each having a series of paired grooves in its opposite sides which are closely spaced apart in succession along the height of the respective post; and a page retainer slightly thinner than the post grooves and having openings positioned, shaped and dimensioned to enable the retainer to be slid down over the posts holding a stack of loose-leaf pages and then shifted horizontally for locking engagement in the post grooves immediately above the top of the stack to retain the stacked pages in the binder.

Further aspects and advantages of this invention will be apparent from the following detailed description of two presently preferred embodiments thereof, with reference to the accompanying drawings.

### BRIEF DESCRIPTION OF THE DRAWINGS

FIG. 1 is an exploded perspective view of a post binder in accordance with a first embodiment of the present invention;

FIG. 2 is a perspective view of the post unit in this binder;

FIG. 3 is a perspective view similar to FIG. 1 and showing loose-leaf pages stacked on the post unit of the binder and the page retainer detached;

FIG. 4 is a perspective view similar to FIG. 3 and showing the page retainer attached to the post unit on top of a stack of loose-leaf pages;

FIG. 5 is a view similar to FIG. 4 and showing a taller stack of loose-leaf pages held in the binder;

FIG. 6 is a perspective view of a second embodiment of the page retainer in the present binder; and

FIG. 7 is a perspective view similar to FIG. 5 and showing the page retainer of FIG. 6 holding a stack of loose-leaf pages on a post unit as shown in FIG. 2.

### DETAILED DESCRIPTION OF THE INVENTION

Before explaining the present invention in detail it is to be understood that the invention is not limited in its application to the particular arrangements shown and described since the invention is capable of other embodiments. Also, the terminology used herein is for the purpose of description and not of limitation.

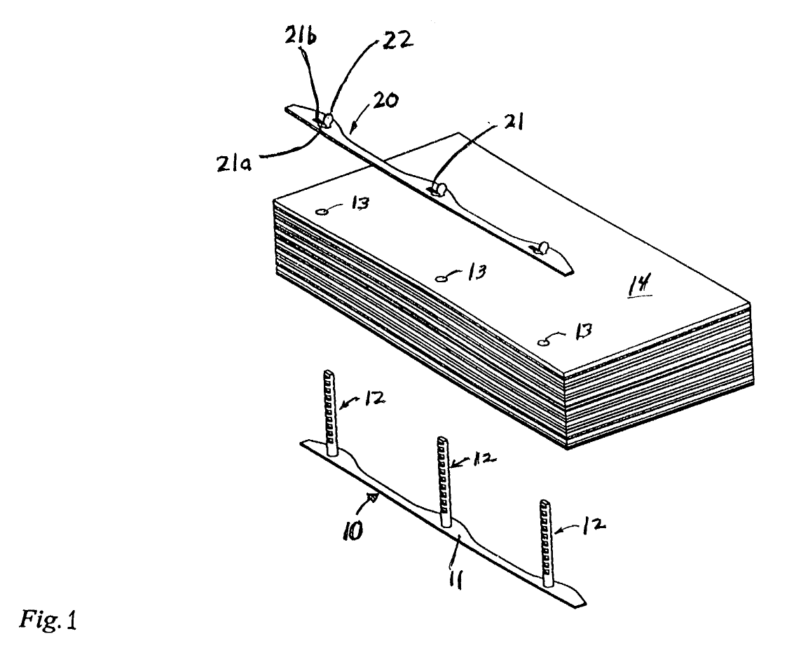

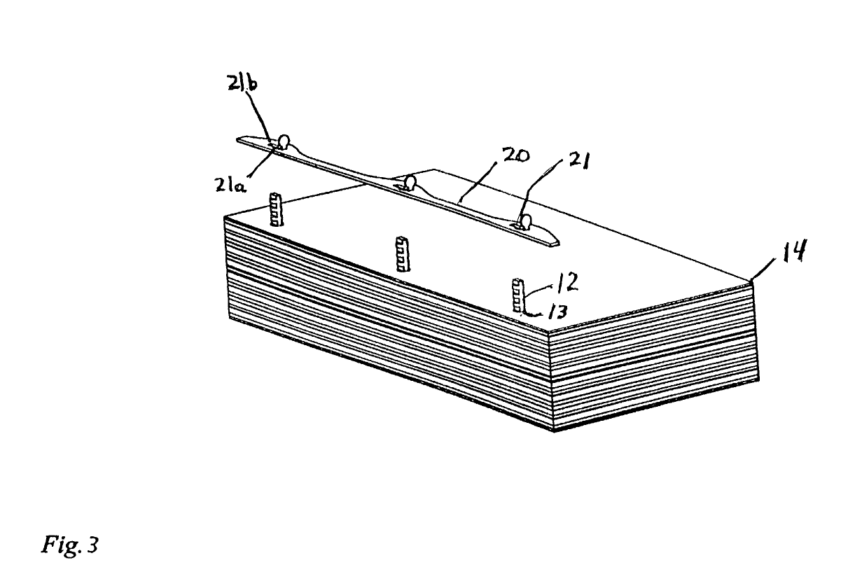

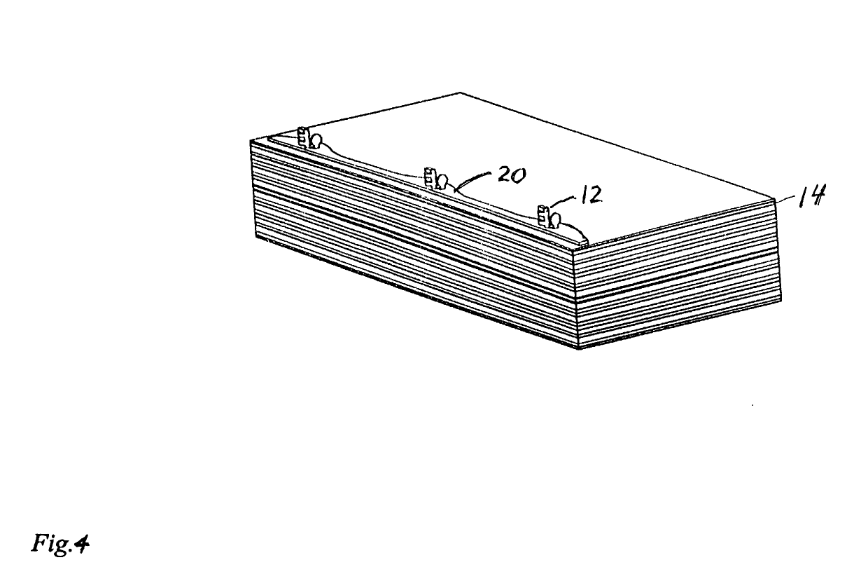

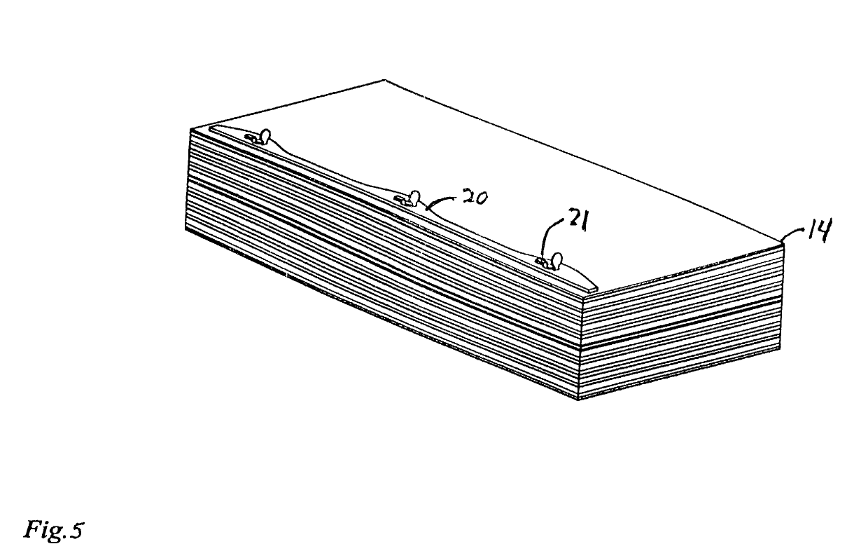

First Embodiment—FIGS. 1-5

Referring to FIG. 1, in this first embodiment of the invention the binder consists of a post unit 10 and a page retainer 20.

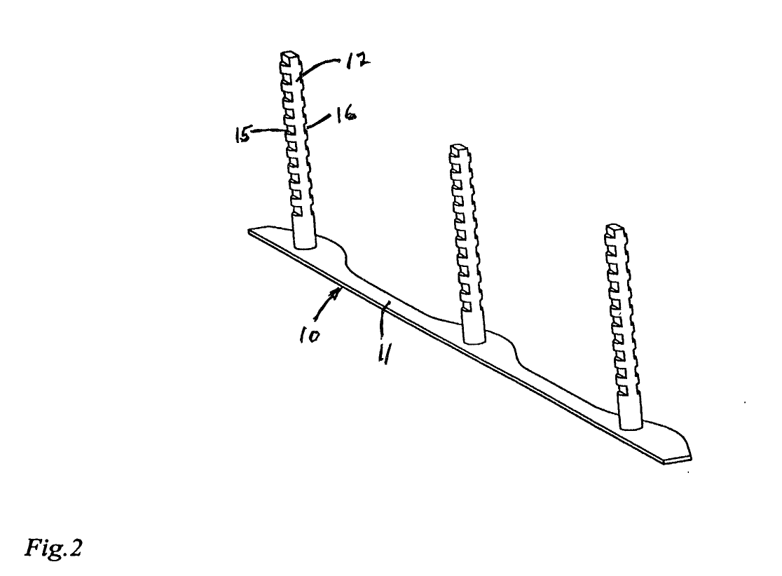

The post unit 10 has an elongated, thin, flat base 11 of sheet metal or suitable plastic and a plurality of identical posts 12 extending perpendicularly up from base 11 at spaced locations along the length of the base corresponding to the spacing between successive openings 13 in loose-leaf pages 14 that are to be stacked on post unit 10. Commonly, there will be three openings in each loose-leaf page and therefore three posts 12 are shown in post unit 10. However, it is to be understood that there may be just two openings, or four or more, in the loose-leaf pages, in which case a corresponding number of posts 12 will be provided in the post unit of the present binder. As best seen in FIG. 2, each upstanding post 12 of post unit 10 is of solid cylindrical configuration, with a plurality of paired sets of external grooves 15 and 16 located in its opposite sides in close succession along the height of the post away from base 11. Each of these grooves has a rectangular cross-section vertically of the post, and is formed with flat, horizontal, upper and lower faces and a flat vertical face at the base of the groove.

The page retainer 20 is an elongated, thin, generally flat, plate-like member of sheet metal or suitable plastic. Preferably, the page retainer is the same shape as base 11 of the post unit 10 and it has a thickness slightly less than the vertical dimension of each post groove 15 or 16. Page retainer 20 present a plurality of keyhole-shaped openings 21 that are spaced apart along its length the same as the spacing between the posts 12 of post unit 10. Each of the retainer openings 21 has a circular larger first portion 21a that is shaped, dimensioned and positioned to slide down over the corresponding post 12 of the base unit and a rectangular smaller second portion 21b connected to its first portion 21a on one side and shaped, dimensioned and positioned to snugly but slidably receive the corresponding post 12 at any of its sets of paired grooves 15 and 16. The width of the narrower rectangular portion 21b of each retainer opening 21 is slightly greater than the horizontal dimension of each post 12 between the grooves 15 and 16 of each paired set and is substantially less than the circular diameter of the corresponding post, so that the page retainer is held firmly in the post grooves and it holds the stack of loose-leaf pages firmly in place.

In this first embodiment of the invention each opening 21 in the page retainer is formed by a punching operation which leaves an upstanding tab 22 attached at the opposite end of the opening from its smaller rectangular portion 21b.

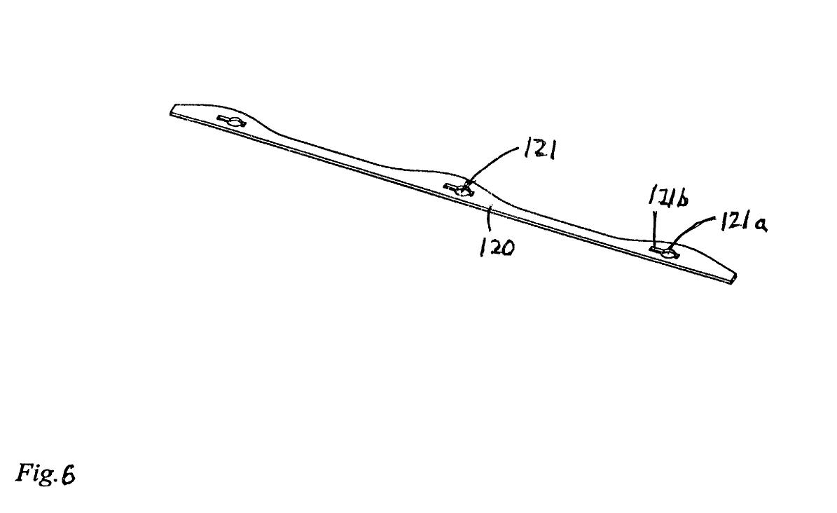

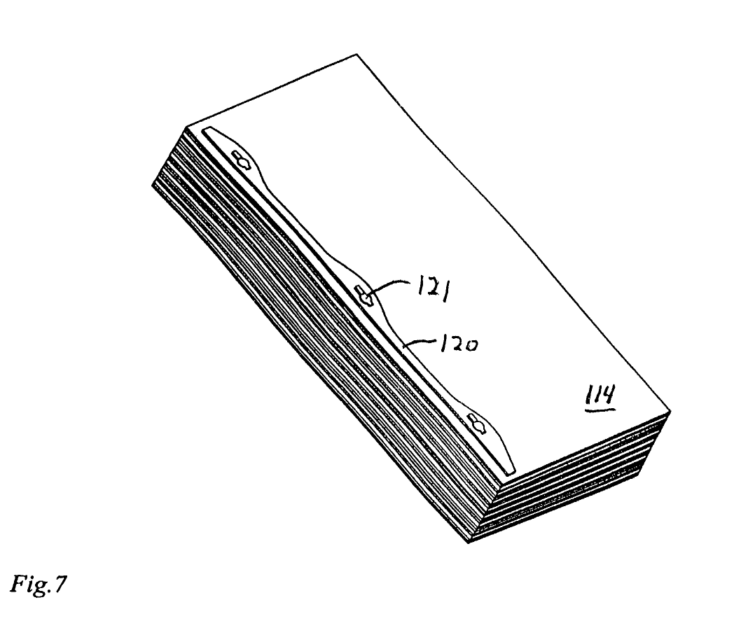

Second Embodiment—FIGS. 6 and 7

In FIGS. 6 and 7 elements of the post binder which correspond to elements of the first embodiment are given the same reference numerals, plus 100, as those in FIGS. 1-5 so that the detailed description of these corresponding elements need not be repeated.

The post unit of the second embodiment is identical to the post unit 10 of the first embodiment.

The page retainer 120 of the second embodiment differs from the page retainer 20 of the first embodiment only in that the tabs 22 of the first embodiment are removed, so that the top of page retainer 120 is flat throughout.

From the foregoing description and the accompanying drawings it will be evident that the present invention enables a user to conveniently bind a stack of loose-leaf pages whose height may change as the user adds and removes pages, with the binder being constructed and arranged to accommodate whatever number of pages the user chooses to stack, limited only by the height of the grooved posts in the binder.

What is claimed is:

1. A post binder comprising:
a post unit having a base and a plurality of posts extending perpendicular to said base and spaced apart in accordance with the spacings of openings in loose-leaf pages to be stacked on said post unit, each of said posts having a plurality of external grooves therein spaced apart in close succession along said post away from said base;
and a page retainer for overlying engagement with a stack of loose-leaf pages on said post unit, said page retainer having a plurality of openings therein spaced apart in accordance with the spacings of said posts of the post unit, each of said openings in the page retainer having a larger first portion thereof shaped and dimensioned to pass the corresponding post of the post unit when the page retainer is slid down over the posts and having a smaller second portion thereof next to said larger first portion which is shaped and dimensioned to snugly but slidably receive the corresponding post at any of said grooves therein when the page retainer is shifted horizontally after being slid down over said posts.

2. A binder post according to claim 1, wherein said grooves in the posts are arranged in paired sets of grooves in opposite sides of the respective post at the same level.

3. A post binder comprising:
a post unit having a base and a plurality of solid cylindrical posts extending perpendicularly up from said base and spaced apart in accordance with the spacings of openings in loose-leaf pages to be stacked on said post unit, each of said posts having a plurality of paired sets of external grooves in opposite sides of the post in close succession along the height of said post, the grooves of each paired sat being at the same height on the respective post;
and a page retainer for overlying engagement with a stack of loose-leaf pages on said post unit, said page retainer having a thickness slightly less than the vertical dimension of each post groove and having a plurality of keyhole-shaped openings therein spaced apart in accordance with the spacings between successive posts of the post unit, each of said openings in the page retainer having a circular first portion thereof shaped and dimensioned to pass the corresponding post of the post unit when the page retainer is slid down over said posts and having a narrower rectangular second portion thereof next to said circular first portion which is shaped and dimensioned to snugly but slidably receive the corresponding post at any of said paired sets of grooves therein when the page retainer is slid down over said posts.
